(19) United States
(12) Patent Application Publication
(10) Pub. No.: US 2012/0317280 A1
(43) Pub. Date: Dec. 13, 2012

(54) SYSTEM FOR SCALING A SYSTEM OF RELATED WINDOWS-BASED SERVERS OF ALL TYPES OPERATING IN A CLOUD SYSTEM, INCLUDING FILE MANAGEMENT AND PRESENTATION, IN A COMPLETELY SECURED AND ENCRYPTED SYSTEM

(76) Inventors: THOMAS LOVE, Cromwell, CT (US); Paul James, Ware, MA (US)

(21) Appl. No.: 13/492,440

(22) Filed: Jun. 8, 2012

Related U.S. Application Data
(60) Provisional application No. 61/494,465, filed on Jun. 8, 2011.

(51) Int. Cl. G06F 15/173; H04L 9/00

(52) U.S. Cl. 709/224

(57) ABSTRACT

The described embodiment of the system includes business methods and software and hardware that creates a cloud based Windows operating system server system that provides education and collaboration tools and system s to general education providers, business entities, and medical professionals and patients, and provides a system of real time delivery of services and information to users. The system uses SSL, AES, RC6, SHA, and UDP VPN over SSL, along with HMAC style logins to provide end-to-end security from within and external to the cloud. It provides online collaboration including live video streaming, email, SMS and live chat. It provides file handling for the conversion of paper medical records into electronic versions.

### CROSS-REFERENCE TO RELATED APPLICATIONS

This application claims the benefit of Provisional Patent Application Docket No. 61/488,596, U.S. Provisional Patent Application Docket No. 61/489,024 and U.S. Provisional Patent Application Docket No. 61/494,465 and U.S. Provisional Patent Application Docket No. 61/494,627 which are incorporated by reference.

### BACKGROUND OF THE INVENTION

1. Field of the Invention

This application relates to Windows OS cloud based web sites, web servers, video servers, file servers, email servers databases, display of digital video files and other digital files, web-based user collaboration tools including video conferencing digital video files, digital video cameras, software conversion of video file formats, end-user software to convert and manage digital video files and other large digital files, delivery of such files to and from remote servers, and scalability systems and methods, in the context of an online collaborative education, information storage and distribution systems, including online educational institution and department organization and management, teacher, student and administrator management, educational course and class organization, online test preparation and administration, online educational collaboration, medical professional-patient interaction and collaboration. It also relates to the acquisition and conversion to appropriate file types for presentation on the Internet, including paper medical record acquisition and conversion and the provision of services and information through a cloud based system.

2. Description of Related Art

Cloud systems are new, and Windows based cloud systems are newer. Until very recently, cloud systems were Linux based. Linux configuration and setup can be command line driven in contrast to Windows, and is simpler to replicate and scale. Windows requires complex multi-step configuration and executables to configure and scale. Thus it is extremely difficult to scale Windows based servers without manual intervention.

Providing end to end security including disk and file encryption and encrypted network communication in cloud systems is even more difficult in scalable Windows based systems and difficult even in Linux systems without manual intervention. Providing front end security through web servers in a scalable system including remote DNS servers, and back-end encrypted network communication, in addition to scalable encrypted disks systems, is extremely difficult without manual intervention.

The Internet currently does not provide simple user-generated multi-hour videos in high security systems through cloud computing. These features are crucial in educational settings.

Education and collaboration systems are predominately local server based. This causes bandwidth problems and support problems, as managing video management systems is quite difficult. There are no online video editing capabilities available in education systems. The Internet currently does not provide user-generated file sharing in standard web ready formats (such as SWF and PDF) in high security systems through cloud based Windows systems. These features are crucial in educational settings.

High security interactive environments require detailed auditing of user behavior to comply with legal and professional requirements. Such systems are not yet on offer in cloud based Windows systems. Medical security demands Scalability, versatility and security combined are extremely difficult and crucial to any number of secure cloud based systems, including those regulated by statutes such as HIPAA.

### BRIEF SUMMARY OF THE INVENTION

The embodiment of the system described herein consists of software, hardware and systems comprising following:
all of the elements cross referenced patents
general education and collaboration system for managing educational organizations, users, students, teachers, course, classes, events and tests and collaborative projects
medically oriented education system for managing medical organizations, medical professionals, patients, and medical suppliers
real time provision of information and services from suppliers
a paper records conversion system to digital formats for use by medical professionals
business methods to manage the system

### BRIEF DESCRIPTION OF THE DRAWINGS

FIG. 1 is an overview of the components of the general education system

FIG. 2 is an overview of the education system

FIG. 3 is a description of the test creation and delivery process.

FIG. 4 is a description of the classroom process.

FIG. 5 is a description of the event process.

FIG. 6 is an overview of the components of the medical collaboration system.

FIG. 7 describes the structure of the medical collaboration system.

FIG. 8 describes the standard medical professional/patient process.

FIG. 9 describes the resource use system process.

FIG. 10 describes the medical record transfer system process.

FIG. 11 is a description of the demographic system process.

### DETAILED DESCRIPTION OF THE INVENTION

### General Education/Overview

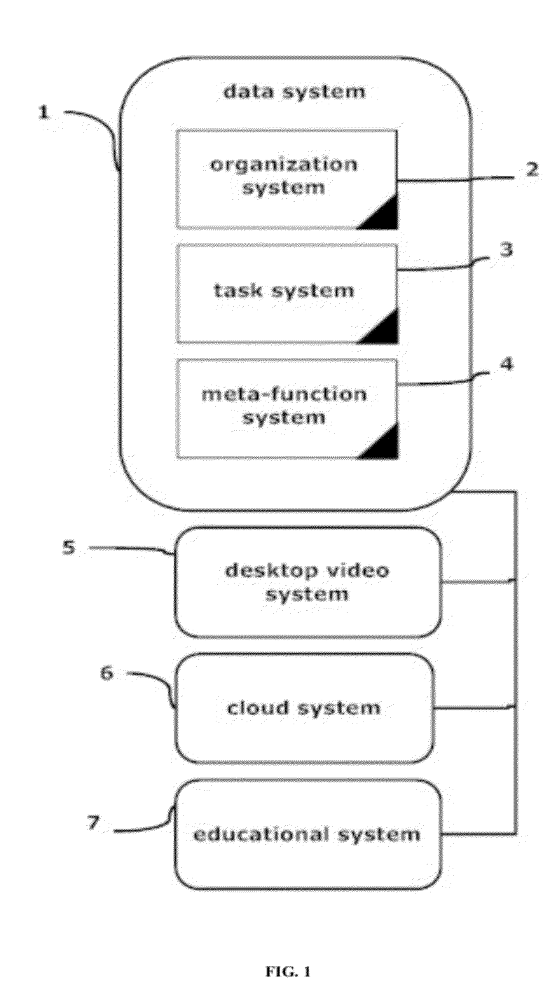

This portion of the description is related to the general education system. The general education system provides a collaborative system for education for college and secondary school, corporate and individual educators, and a project collaboration system, and uses all the features of the cross-referenced patent applications. FIG. 1 is an overview of the components of the general education system.

FIG. 1, data system, item 1. All components of the data system described in the associated U.S. Provisional Patent Application 61/488,596 are used in this system. Special note is taken of the organization system, the task system and meta-system in general, including the collaboration system, the publication system and the billing system.

FIG. 1, data system, organization system, item 2. The organization system anticipates large multi organizational unit (AOUNIT@) multi-level systems, and single level small organizations. This is supported by a single OUNIT table using the parent row zero feature described in the associated U.S. Provisional Patent Application 61/488,596

Users join the system either by signing themselves up or by being signed up by an existing user with authority to do so. If the user is signing themselves up, they are added to a new OUNIT. If they are signed up by an existing user, then the new user (likely to be a student) is assigned to the existing user=s selected OUNIT. The new user=s task in the new OUNIT are controlled by the existing user.

Table 1 is a description of the types of organizations accommodated by the system.

TABLE 1

| Type | description |
|---|---|
| large | The organization is the first created OUNIT, departments within the |
| organizations | organization are child OUNITS (using the parent row feature), and user |
| | records are linked to OUNITS through the user link table. All |
| | organizations have an initial default OUNIT to which the initial master user |
| | is linked. Large organizations includes colleges, secondary schools, |
| | professional organizations, large business entities, and adult education |
| | systems. |
| professional | The individual medical professional is assigned to their initial OUNIT, |
| individual/small | which is created by the system for them. The medical professional then |
| supplier | The education supplier organizations provide video and other education |
| | material to education professionals. The initial OUNIT represents the |
| | company, child OUNITS are marketing/sales departments by market |
| | segment. The users are the sales force of the organization. User link |
| | connections with teachers done through the user link table - the users are |
| | added by the educational supplier=s users by searching for appropriate |
| | demographics among the teachers. This is an opt out system, that is the |
| | suppliers can connect to the teachers directly, and then the teachers must |
| | opt out. |

FIG. 1, data system, task system, item 3. The task system in this embodiment specifically groups tasks into roles such as administrator/teacher/student and assigns them to the OUNIT-user link table—this enables roles of users to be different depending on the OUnit link, and to be mixed and matched in a single OUnit-user link. The task assistant feature and task tracking are emphasized.

Table 2 is a description of task groupings.

TABLE 2

| role | description |
|---|---|
| teacher | can create and manage courses and events and projects |
| administrator | create students, teachers, collaborators and tech support |
| task | each user can appoint a task assistant to a particular task |
| assistant | which user can then act in the name of the delegator in |
| | respects of all aspects of that task. |
| supplier | can distribute video and files to demographically identified |
| | consumers |

Users can have tasks assigned to them, and optionally the ability to assign the same tasks to others. Tasks follow the hierarchy of Organization (parent OUNIT)/OUNIT/User. Tasks are generally add/edit/delete objects in the system.

Table 3 lists user management tasks.

TABLE 3

| | |
|---|---|
| manage OUNITS | add/edit/delete OUNITS, all child tasks |

Link tables between an education table and the user table contain a field for the task ID that enables the link. Tasks that enable links are teacher, administrator and student (collaborator), or speaker, administrator and attendee. Teacher has full rights over all records, administrator has read only rights over all records, student has read-only over administrative portions of their records (attendance, grades), and full rights over content elements. With respect to events, speaker has content rights, administrator of events has full rights, and attendee has rights similar to student.

Table 4 describes tasks associated with the general education system.

TABLE 4

| task | description |
|---|---|
| manage courses | add/edit/delete course, add/edit/delete class records, associate student |
| | users - associate files and videos with each class and with the course |
| | master record, edit all data therein, associate other managers |
| manage events | add/edit/delete events, add/edit/delete seminar records, associate speakers |
| | and attendees - associate files and videos with each event and seminar, edit |
| | all data therein, associate other managers |
| manage projects | add/edit/delete projects, associate collaborators, associate files and videos |
| | with each event and seminar, edit all data therein, associate other managers |
| manage | add/edit/delete and create links to classes and courses |
| assignments | |
| assistants | the assistant task is enables a teacher to appoint an assistant who can do all |
| | of the tasks of the teacher in the teacher=s name |
| attend | attend as student, teacher or administrator and exercise such rights over |
| course/class | the course, drill down to class |
| attend | attend as speaker, administrator or attendee and exercise such rights over |
| event/seminar | the event, drill down to seminar |
| work on project | collaborate on the project |
| manage tests | create/edit/assign tests. Assign includes link to a class/course/assignment |
| | and put time parameters - range when test can be started, how long the |
| | test can be taken and whether video proctoring is required |
| take tests | students taking the test, creates the rows in the test table for the student |
| | and tracks the test taking session. |
| resource - | create a resource, attach providers to the resource |
| manage | |
| resource - request | request a resource |
| supplier tasks | upload manage videos and files, |
| | deliver to demographics, |
| | review accesses |
| | communicate with viewers |
| | manage professional links |
| | search and add links to professionals in the system |
| | add professionals not yet on the system |

In addition to auditing all changes made to all records in the database as described in the provisional U.S. Provisional Patent Application 61/488,596, the educational system tracks all activities on the system. The system tracks all accesses of records in the database and all file accesses. These statistics can be viewed online using the audit toolbar function or downloaded in spreadsheet form.

Table 5 describes the elements of the system that are tracked and audited.

TABLE 5

| component | description |
|---|---|
| audit | the database system audits all changes to all records |
| | in all tables |
| object access | all educational system object access is tracked |
| tracking | |
| attendance | attendance is tracked by time stamp fields in link |
| | records |
| file and | all file/video views are tracked by the database system |
| video views | |
| file | all file/video views are tracked by the database system |
| download/uploads | |
| participation | participation in chats and other collaborative items |
| in chats | is tracked |

FIG. 1, data system, meta-function system, item 4. All features of the meta function system are used but a particular emphasis is placed on the following elements.
Collaboration: collaboration is used in connection with each element of the education system.
Video and file sharing: the video system is used to record all educational events and deliver them later, and optionally in connection with the collaboration system. The file system is used to deliver educational material with each element of the educational system.
Libraries: videos and non-video files can be collected into libraries and then attached to any other record in the system. This enables teachers to group instruction material.
Publication: the publication system is used to provide public access to courses and events, both for educational and advertising purposes. Teachers can publish courses, classes, assignments, events, seminars and videos and files.
Task tracking and auditing: task tracking and audit is used in connection with student supervision and tracking.
Billing: The billing system is used primarily by smaller education customers to provide a billing system for access to courses and events. As described in the associated patent application, the accounting database contains linked tables providing billing algorithms, charges, adjustments and payments. Access to OUNITS, courses, classes, events and sub-events can be billed using any of the therein described algorithms.

FIG. 1, desktop video, item 5. The desktop video system is described in the cross referenced U.S. Provisional Patent Application 61/489,024. The desktop system including the video and non-video file processing application (AVNFPA@) is a crucial component of the education system, enabling teachers to simply and asynchronously record teaching material.

In the case of pre-recorded video, the teacher records the instruction, together with blackboard/whiteboard or PowerPoint if needed, outside of a classroom. Usually each point is recorded separately and put together on the system using the play list function. The video can be displayed thereafter on demand by the students, can be associated with a class or event, and can be delivered simultaneously with a chat session by the instructor.

In the case of live streamed video, live classroom or seminar sessions can be streamed and recorded live, uploaded to the system, and displayed thereafter either on demand or with a simultaneous chat session with the presenter.

FIG. 1, cloud system, item 6. The cloud system is described in the cross referenced U.S. Provisional Patent Application 61/494,465. It is used herein in its entirety.

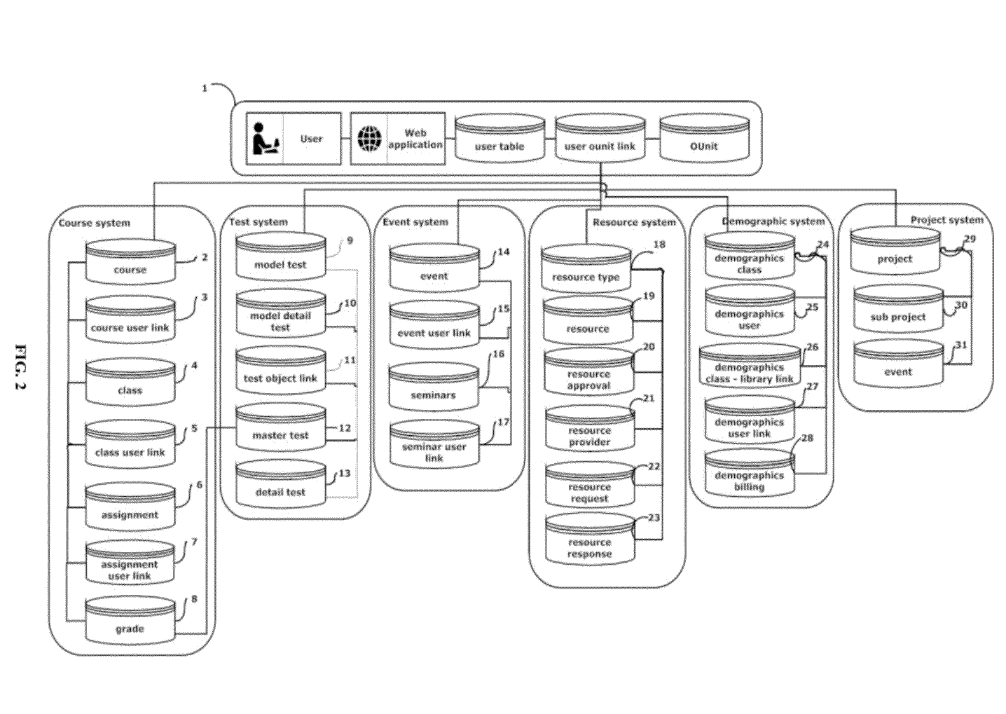

FIG. 1, education system, item 7. The educational system is the data structures and interactions with the data system, job and task system, as well as the other features of the other aforementioned elements, that manage and organize the interaction of the users of the system in an educational context. The education system consists of the following components, course, test, event, resource request and demographics. FIG. 2 is an overview of the education system.

FIG. 2, user OUNIT system, item 1. All links in the system start with the user-web application-user table-user OUNIT link table, which itself links users to OUNITS.

FIG. 2, course table, item 2. The course table is the central organizing table for the course component. It contains the course description start dates and end dates where the course record and its subsidiary records are active, and the toolbar functionality, which provides course level communication between instructors and students. Courses can be either sequence courses or date courses. Date courses have classes that are held on specific dates and have overall start/end periods. Sequence courses are courses that can be started by individual students at any time. Sequence courses can be mandatory (that is, the teacher must approve advancement from one class to the next) or non-mandatory (all classes are available to the student at once).

A user who is authorized by the task system to manage courses would start the course creation process by creating a course record in the database.

FIG. 2, course user link table, item 3. The course user link table links users to courses and enables the course level collaborative toolbar for the user. The table includes a task ID field which indicates which task is granting access to the course for the user—teacher, administrator, student.

The course creation process would proceed with assignment of student tasks to users in the OUnit who are to be students in this course (if that hasn=t been done previously), and then linking the students to this course record.

FIG. 2, class table, item 4. The class table a child table of the course table and is the organizing element for classes. It contains descriptive data, valid date ranges, etc. It provides class level communication with students. There is one record for each class. The course creation process would proceed with the creation of the individual class records.

FIG. 2, class user link table, item 5. The class user link table links users to courses and organizes information such a grade, attendance etc. and enables the class level collaborative toolbar for the user. When a class record is created, the system automatically links all of the users in the course to it. These links can then be altered by the course creator, if need be.

FIG. 2, assignment table, item 6. The assignment table is a child table of the course table and is the organizing table for assignments. It can also be made a child of the class table. It contains descriptive data and links to file libraries comprising the assignment (video and non-video files) and enables the collaborative toolbar for the assignment. The course creation process would require the teacher to organize assignments from the libraries of video and non-video files provided by the course creator.

FIG. 2, assignment user link table, item 7. the assignment user link table links users to assignment. If assignments are to be assigned to groups of students, then a separate assignment would be made for each group of students. The system automatically links all students to all assignments, which links can then be edited by the course creator.

FIG. 2, grade table, item 8. The grade table can be linked to courses, classes, assignments and tests, on the one hand, and users on the other. The grade table contains the grade for the linked element. This table is managed by the course creator.

FIG. 2, model test table, item 9. The model test table is the source table for stored tests, and is linked to creator/editors of the test in a direct parent child relationship. This table holds the test level meta data.

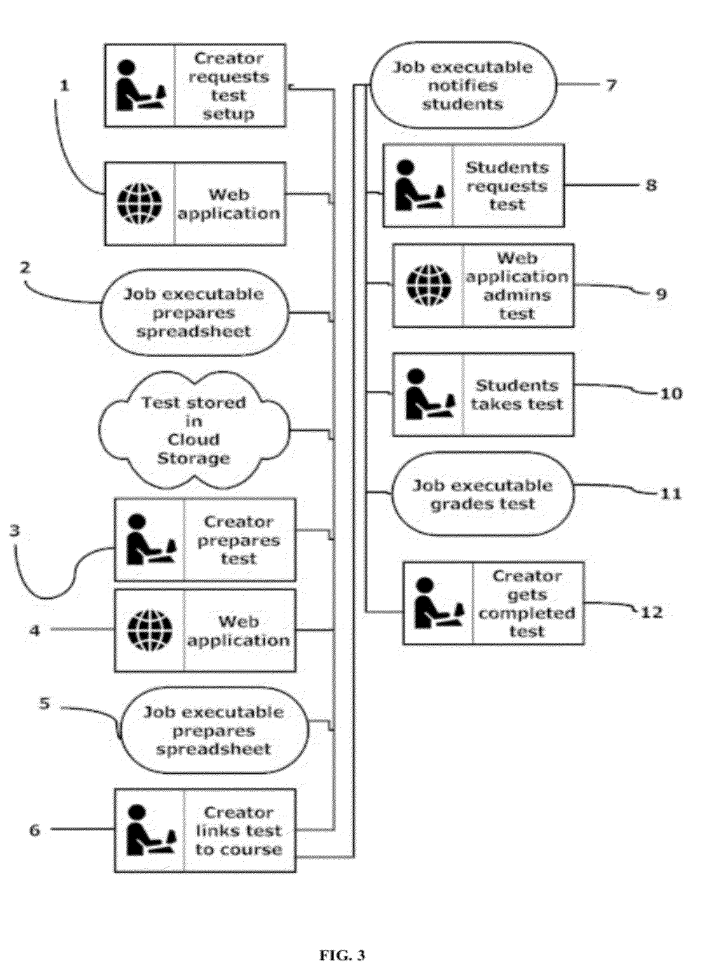

A course creator creates the test record, and is sent by the system the source spreadsheet to be used to create the test. The system includes a job server/spreadsheet driven testing facility. The first sheet contains meta-information about the test. The second sheet contains the test, with columns as indicated above. FIG. 3 is a description of the test creation process.

FIG. 2, model detail test table, item 10. This is a child of the model test table. It contains each question of the test in a single row.

Table 6 describes the fields in the model test detail table.

TABLE 6

| field name | description |
|---|---|
| sequential | The sequential number maintains the order of questions. |
| number | |
| question | This is the text of the question. |
| answer type | This is a choice by the test creator as to the type of |
| | answer. It can be text(length) - t/f - numerical |
| | value - multiple choice. |
| multiple choice | This holds the answer for multiple choice questions. |
| answers | |
| explanatory | This is optional explanatory text. |
| text | |
| explanatory | This is optional explanatory images. |
| images | |
| answer | This is the correct answer. If the question is a text |
| | question, then this is optional |
| answer text | This is the optional answer explanation. |
| explanation | |
| result | This is the system evaluation of student answer (correct |
| | or incorrect) - 0 correct, 1 incorrect, 2 not evaluatable |
| | (text answers) |

FIG. 2, test object link table, item 11. This table links tests to courses, classes or assignments. It uses the object linking table described in the database provisional application to link the test to courses, classes or assignments. In includes meta data such as when the test can be taken. These links are created by the course creator.

FIG. 2, master test table, item 12. this table organizes each test, and is a child of the model test table, the test object link table and the objects user link table. This is the Alive@ test table. This table is created when a user starts taking the test.

FIG. 2, detail test table, item 13. This table contains one row per test question and records the users answers. It is a child of the master test table. The questions are created when the user starts the test, and are created based on the model detail test table.

FIG. 2, event table, item 14. The event table is the organizing table for events, which are in the nature of virtual conventions or educational trade shows. Events act as a grouping mechanism for seminars or individual speeches. The chief difference between events and courses is the lack of grades or testing with events. Events are created by the event manager.

FIG. 2, event user link, item 15. The event user link table links users to events. The table includes a task ID field which indicates which task is granting access to the course for the user—speaker, administrator, attendee. The event manager manages this table.

FIG. 2, seminars, item 16. The seminar table relates to a single presentation, whether of video or non-video material. It is similar in idea to a class, i.e., a single session meeting or presentation. The event manager creates these records.

FIG. 2, seminar user link table, item 17. The seminar user link table links individual users to seminars, for attendance or security purposes (the seminar can be marked closed except for pre-listed attendees. User links are created when the seminar is created, by linking all of the users linked to the event. This can be edited by the event manager.

FIG. 2, resource system, type table, item 18. Resources are services provided on an immediate call basis, such as tutoring, software, consulting. Resources can consist of a service provided by a single person, or one provided by many people or automatically by software. These are services which are pre-configured by an OUNIT (prequalified, payment methods established) and then are made available to members of an OUNIT.

The resource type table is a classification table maintained by the system staff which organizes into understandable categories the types of resources available to users. It uses the parent row zero feature to create hierarchical lists of classes.

FIG. 2, resource system, resource table, item 19. The resource table is a one row per resource table maintained by resource providers. Private resources are those available only to a singe OUNIT (one resource can have many private OUNIT links) Public resources are resources provided by third parties and are available to all OUNITS, subject to individual OUNIT approval. Also, public resources can be displayed on the system=s public web site for the general public to review, at the option of the resource provider.

FIG. 2, resource system, approval table, item 20. The resource approval table is a resource to OUNIT link table and indicates whether a particular resource is approved by a particular OUNIT.

FIG. 2, resource system, resource provider link, item 21. The resource user link table links the user record of the providers of the resource to the resource record. One or more users may provide the resource. This record includes the days and hours of availability of individual resource providers.

FIG. 2, resource system, resource request, item 22. The resource request table holds the records for each resource request. A requesting user selects a resource and a record is created in the resource request table to manage the process.

FIG. 2, resource system, resource response, item 23. Each provider connected to a resource is notified of each qualifying resource request and a record for each provider and each request is added to the resource response table. The requestor can see all the responses, the provider only theirs. This record tracks the responses to the request and the requestor=s response and selection process.

FIG. 2, demographics system, class table, item 24. The demographics system is intended to enable suppliers to provide content and software services of the type that do not require human intervention to users of the system. This table is the list of demographic classes. It is maintained by the system administrators. It uses the parent row zero feature to create hierarchical lists of classes.

FIG. 2, demographics system, user table, item 25. Users provide demographic information about themselves when they join (job class, geographic location). This information is used to channel prospective supplier solicitations to potentially interested teacher customers. The supplier uploads the video and non-video files to their account, and then identifies the demographic for delivery. The information is immediately available to all qualifying users, sometimes for free, sometimes on a pay per use bases. Teachers who view the material are jointly identified to the supplier and themselves.

FIG. 2, demographics system, class link table, item 26. The demographic class link table links demographic classes to supplier libraries. If the supplier=s service is geography limited, that information is included in the link. Other access requirements (limited time, specific URL or IP address, etc.) are also included.

FIG. 2, demographics system, user link table, item 27. The demographic user link table links users to supplier libraries. When a user finds supplier material that the user wants to access, this table creates the link. A second link is created for the object being linked to, in this case, a patient, or possibly an educational seminar. The link also includes the access limitations, such as time period.

FIG. 2, demographics system, billing table, item 28. The demographic billing table powers the billing system for suppliers and is linked to the demographic user link table. The demographic billing table records the terms of access to a library. The billing system is further described in U.S. Provisional Patent Application 61/488,596.

FIG. 2, project system, project table, item 29. The project system is a simplified version of the course system. The project system provides a less structured system for online collaboration. Participants contribute to, and evaluate the contributions to, the project jointly.

FIG. 2, project system, sub project table, item 30. Sub projects can be created by the project creator, and can have such participants as the project creator chooses. The sub projects use the parent row feature described in associated U.S. Provisional Patent Application 61/488,596 to link to each other and the parent project.

FIG. 2, project system, event table, item 31. The event table provides a user oriented list of all activities in the project and any sub projects that the user has access to so that users are immediately up to date with all activities. This uses the universal table row linking system described in associated U.S. Provisional Patent Application 61/488,596.

### General Education/Scenarios/Test Taking

FIG. 3 describes the test preparation and administration process. The system provides a spreadsheet integrated method of creating tests offline, and then administering them online FIG. 3, test creator, item 1. The user requests web application to enter a job re new test setup.

FIG. 3, job executable, item 2. The job executable prepares blank test setup spreadsheet—the first sheet of the spreadsheet contains descriptive fields which map to the parent test table and other meta information—the second sheet contains the question fields described above. The job executable then moves the test to cloud storage, updates the database to notify the user through the application of the URL, and emails the user with the URL.

FIG. 3, test creator, item 3. The test creator prepares the test spreadsheet, and uploads it through a web application link associated with the original user request.

FIG. 3, web application, item 4. The web application enters a job requesting the inclusion of the test in the test database.

FIG. 3, job executable, item 5. The job executable reads the uploaded spreadsheet and populates the model test tables as described above and sends emailed confirmation to the course creator.

FIG. 3, course creator, item 6. The course creator links the test to courses, classes and assignments, with parameters such as the times when the test can be taken, how long the test can be open, and whether video proctoring is required.

FIG. 3, job executable, item 7. The job executable notifies students of the assignment of the test, one day before the test, one hour before the test, and at the start time.

FIG. 3, student, item 8. The student requests a test from the web application.

FIG. 3, web application, item 9. The web application prepares an actual test from model, using tables listed above, creates a video conference link if required for proctoring, and notifies proctor through the job system if needed.

FIG. 3, student, item 10. The student takes the test administered by the web application.

FIG. 3, job system, item 11. The job system grades those answers which can be objectively graded.

FIG. 3, test creator, item 12. The test creator is notified of the completion of the test.

### General Education/Scenarios/Classroom

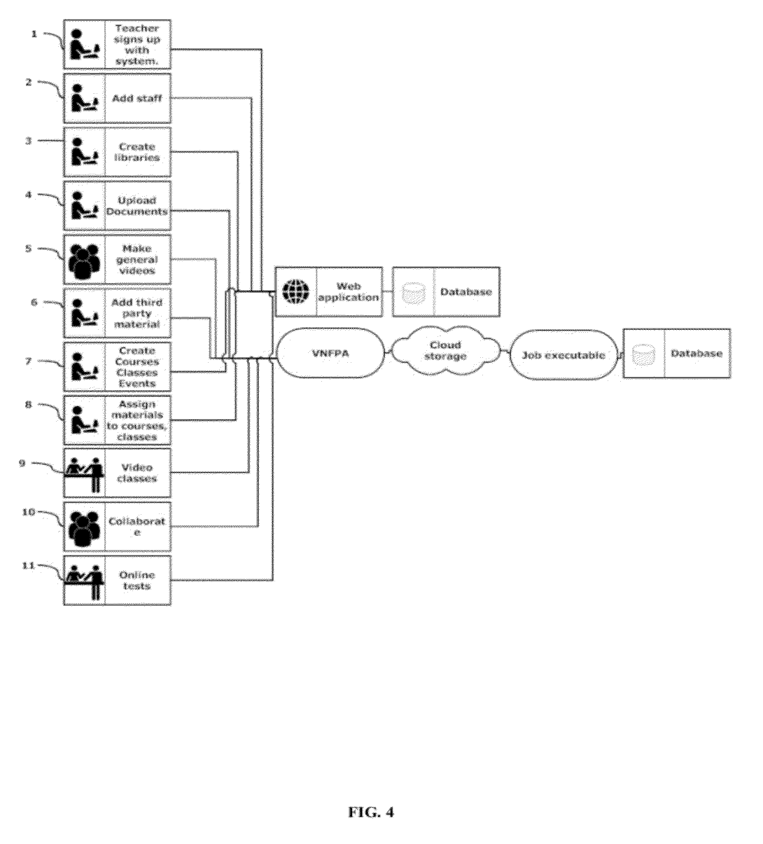

FIG. 4 describes a classroom process using the system. FIG. 4, sign up with the system, item 1. The teacher or staff member signs up with the system (the Afirst user@). This requires the first user=s email address and cloud storage account. A top level OUNIT is created for the first user.

FIG. 4, add staff, item 2. The first user then adds other users to the OUNIT or child OUnits. This requires only email addresses. The first user puts the new users in one of three categories: teacher, staff, or student.

FIG. 4, setup education libraries, item 3. Users create education libraries are created for each type of course. Education libraries organize files and videos into easily assignable groups for use in courses and classes.

FIG. 4, add educational documents, item 4. Users upload documents and other files to each education library.

FIG. 4, make general education videos, item 5. Users acquire cameras and make general educational/education videos for each topic. Teachers can make general videos about topics using inexpensive hi-def cameras. They (or their staff) can then encode, edit, encrypt and upload the videos using the VNFPA or by mailing the SD cards to the system administrators. The videos can be edited online Once the videos are edited and online, the videos can then be assigned to the education libraries.

FIG. 4, add third party materials to libraries, item 6. Users add third party materials (documents, animations, video) provided by third parties through the system. Third parties (usually suppliers to educators) can upload videos and files and make them available to teachers through the anonymous demographic data based system (meaning the teacher=s contact information is not shared with the supplier until the teacher makes use of the material—the material is made available based on the type of subject matter of the teacher). [104] FIG. 4, create courses, classes, item 7. Users set up courses and classes. The education structure follows department/course/class. These are set up to provide an education framework. See FIG. 2 and the associated description.

FIG. 4, assign videos and materials to courses, classes and students, item 8. Users assigneducation libraries to courses, classes and students through the web application.

FIG. 4, video classes, item 9. Teachers users can video sessions with students, using inexpensive hi-def cameras. They can then encode, edit, encrypt and upload the videos using the VNFPA or by mailing the SD cards to the system administrators. The videos can also be edited online Once the videos are edited and online, the videos can then be assigned to the courses, classes and students.

FIG. 4, collaborate, item 10. Teacher users can also use scheduling, video conferencing, email, chat and discussion groups to communicate with students.

FIG. 4, online test taking, item 11. Teachers can also set up and administer online tests. See FIG. 3 and the associated description.

### General Education/Scenarios/Events and Seminars

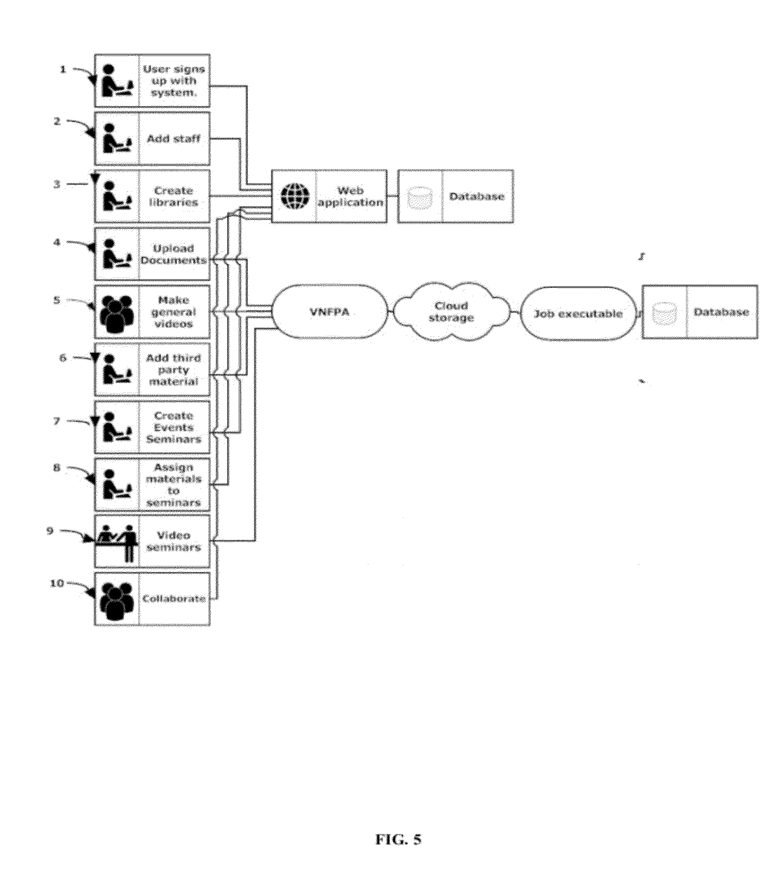

FIG. 5 describes an event process using the system. Events are trade shows and conventions, seminars are seminars with those trade shows and conventions.

FIG. 5, sign up with the system, item 1. The teacher or staff member signs up with the system (the Afirst user@). This requires the first user=s email address and cloud storage account. A teaching organization is created for the first user.

FIG. 5, add staff, item 2. The first user then adds other users to the OUNIT or child OUNITS. This requires only email addresses. The new users are staff. Later on, seminar attendees can sign up in the same manner.

FIG. 5, setup education libraries, item 3. Users create education libraries are created for each seminar. Education libraries organize files and videos into easily assignable groups for use in seminars.

FIG. 5, add educational documents, item 4. Users upload documents and other files to each education library.

FIG. 5, make general education videos, item 5. Users acquire cameras and make general educational/education videos for each topic. Seminar presenters can make seminar related videos using inexpensive hi-def cameras. They can then encode, edit, encrypt and upload the videos using the VNFPA or by mailing the SD cards to the system administrators. The videos can be edited online Once the videos are edited and online, the videos can then be assigned to the education libraries.

FIG. 5, add third party materials to libraries, item 6. Users add third party materials (documents, animations, video) provided by third parties through the system. Third parties (usually suppliers to educators) can upload videos and files and make them available through the anonymous demographic data based system.

FIG. 5, create events, seminars, item 7. Users set up events and seminars. The education structure follows department/event/seminar. These are set up to provide an organizational framework

FIG. 5, assign videos and materials to events, seminars, item 8. Users assigneducation libraries to events, seminars and students through the web application.

FIG. 5, video seminars, item 9. Seminars are simultaneously live streamed and recorded using inexpensive hi-def cameras. The videos are then encoded, edited, encrypted and uploaded using the VNFPA or by mailing the SD cards to the system administrators. The videos can also be edited online Once the videos are edited and online, the videos can then be assigned to the events and seminars and viewed by non-attendees.

FIG. 5, collaborate, item 10. Seminar organizers users can also use scheduling, video conferencing, email, chat and discussion groups to communicate with seminar attendees

### General Education/Scenarios/Resource and Demographics.

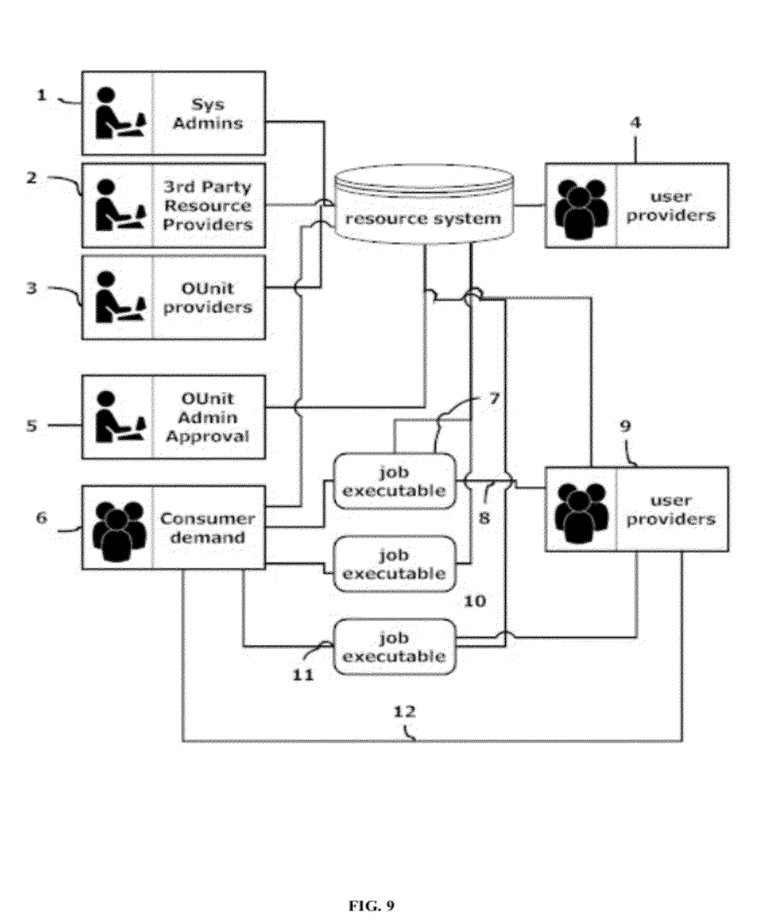

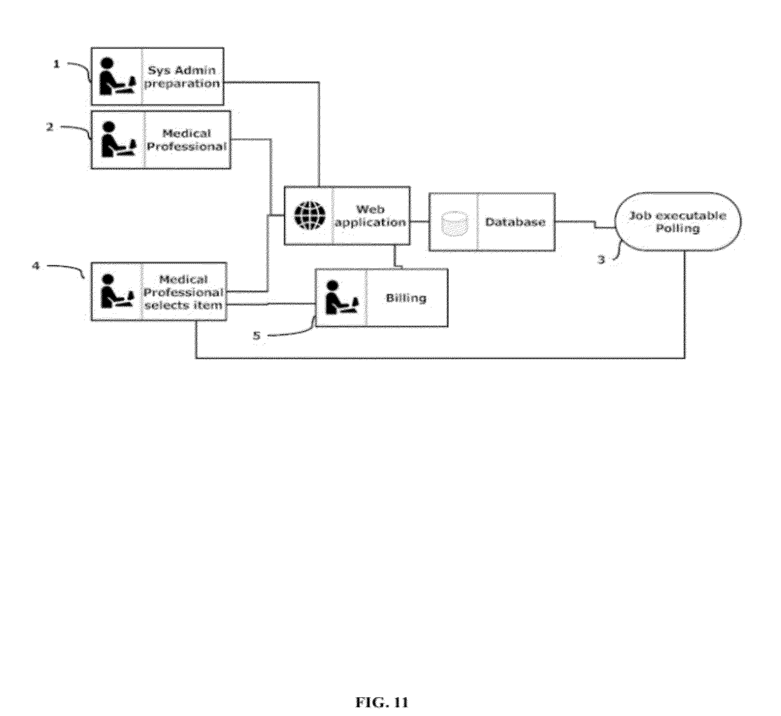

The resource process and demographic process are similar to that used in the medical collaboration system, and FIG. 9 and FIG. 11 discuss those processes.

### Medical Collaboration System/Overview

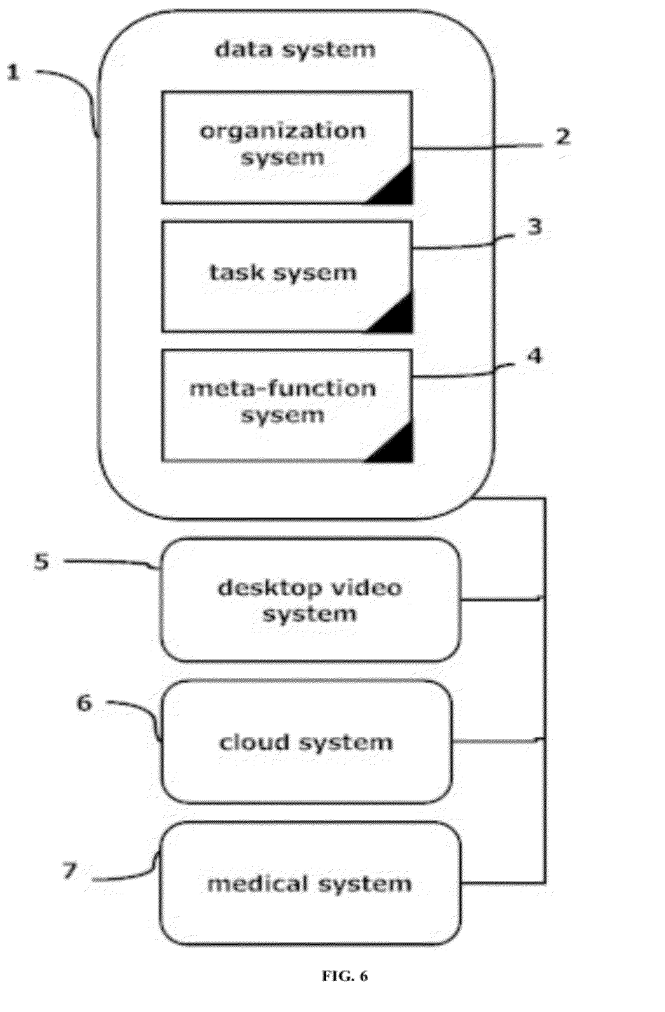

This portion of the description is related to the medical collaboration system. The medical collaboration system provides a collaborative system for education for patients and medical professionals, and uses all the features of the cross-referenced patent applications. FIG. 6 is an overview of the components of the medical collaboration system.

FIG. 6, data system, item 10. All components of the data system described in the associated U.S. Provisional Patent Application 61/488,596 are used in this system. Special note is taken of the organization system, the task system and meta-system in general, including the collaboration system, the publication system and the billing system.

FIG. 6, data system, organization system, item 11. The organization system anticipates large multi organizational unit (AOUNIT @) multi-level systems, single level small organizations. This is supported by a single OUNIT table using the parent row zero feature described in the associated U.S. Provisional Patent Application 61/488,596

Users join the system either by signing themselves up or by being signed up by an existing user with authority to do so. If the user is signing themselves up, they are added to a new OUNIT (typically a medical professional). If they are signed up by an existing user, then the new user (likely to be a patient) is assigned to the existing user=s selected OUnit. The new user=s task in the new OUNIT are controlled by the existing user.

Table 7 is a description of the types of organizations accommodated by the system.

TABLE 7

| Type | description |
|---|---|
| large | The organization is the first created OUnit, departments within the |
| organizations | organization are child OUNITS (using the parent row feature), and user |
| | records are linked to OUnits through the user link table. All organizations |
| | have an initial default OUnit to which the initial master user is linked. |
| | Large organizations include health systems, hospitals, nursing homes and |
| | large group practices. |
| public medical | Public education is through the general education system. |
| educators | |
| small practices | The individual medical professional is assigned to their initial OUNIT, |
| suppliers | Medical supplier organizations provide video and other education material |
| | to educate medical professionals. Organization are companies, OUnits are |
| | marketing/sales departments by market segment. The users are the sales |
| | force of the organization. User link connections with medical professionals |
| | done through the user link table - the users are added by the medical |
| | supplier=s users by searching for appropriate demographics among the |
| | medical professionals. This is an opt out system, that is the suppliers can |
| | connect to the medical professionals directly, and then the medical |
| | professionals must opt out. |

FIG. 6, data system, task system, item 12. The task system is a part of the above referenced data system and in this embodiment specifically groups tasks into roles such as medical professional/patient/administrator/supplier and assigns them to the OUnit-user link table—this enables roles of users to be different depending on the OUnit link, and to be mixed and matched in a single OUnit-user link. Task assistants is used in the medical system.

Table 8 is a description of the task groupings.

TABLE 8

| role | description |
|---|---|
| medical | can create and manage patients and patient education |
| professional | |
| patient | can collaborate with medical professionals and review |
| | online material |
| administrator | manage professionals, assistants and tech support |
| tech support | manage technical elements (backups, logins, etc) |
| task | each user can appoint a task assistant to a particular |
| assistant | task which user can then act in the name of the delegator |
| | in respects of all aspects of that task. |
| supplier | can distribute video and files to demographically |
| | identified medical professionals |

Users can have tasks assigned to them, and optionally the ability to assign the same tasks to others. Tasks follow the hierarchy of Organization (parent OUNIT)/OUNIT/User. Tasks are generally add/edit/delete objects in the system.

Table 9 describes user management tasks.

TABLE 9

| task | description |
|---|---|
| manage OUnits | add/edit/delete OUnits, all child tasks |

Link tables between an education table and the user table contain a field for the task ID that enables the link. Tasks that enable links are medical professional, patient and administrator. Medical professional has full rights over all records, administrator has read only rights over all records, patient has read-only over the education portions of their records, and full rights over collaboration elements. With respect to events, speaker has content rights, administrator of events has full rights, and attendee has rights similar to student.

Table 10 describes tasks associated with the medical collaboration system.

TABLE 10

| task | description |
|---|---|
| manage patients | add patient user master records where none exist - note, if patient is |
| | not on the system at all (as identified by email address) then the |
| | patient is added to the general patient OUnit and linked to the |
| | professional and the professional=s OUnit |
| manage professionals | add/edit/delete professional user link records to patients - new |
| | professional=s are added to both the specific OUnit and the general |
| | professional=s OUnit |
| manage patient | add/edit/delete links to videos and documents from professional to |
| education | patient, manage links to professional=s libraries of videos and files |
| assistants | the assistant task is enables a professional or administrator to |
| | appoint an assistant who can do all of the tasks of the appointer in |
| | the appointer=s name |
| create transfer task | creates the task record and associates it with the requesting and |
| | responding professionals and then sending the responding |
| | professional the task request |
| direct upload | can be performed by the responding professional and the task |
| | creator - HTTPS uploads of files |
| manage emailed image | whether by SSL fax or SSL email - the system staff determines the |
| files | correct task ID and then performs a direct upload |
| assign to patient | the files are assigned to a patient record automatically and |
| | periodically by the job system and can also be associated manually. |
| resource - manage | create a resource, attach providers to the resource |
| resource - request | request a resource |
| resource - respond | respond to resource request |
| supplier tasks | upload manage videos and files, |
| | deliver to demographics, |
| | review accesses |
| | communicate with viewers |
| | manage professional links |
| | search and add links to professionals in the system |
| | add professionals not yet on the system |

In addition to auditing all changes made to all records in the database as described in U.S. Provisional Patent Application 61/488,596, the medical system tracks all activities on the system. The system tracks all accesses of records in the database and all file accesses. These statistics can be viewed online using the audit toolbar function or downloaded in spreadsheet form. These are important both to medical professionals in the course of providing information and to suppliers.

Table 11 describes tracking functions.

TABLE 11

| component | description |
|---|---|
| audit | the database system audits all changes to all records |
| | in all tables |
| session | all logins and sessions are tracked by the database |
| | system (ip address) |
| file and | all file/video views are tracked by the database system |
| video views | |

FIG. 6, data system, meta function system, item 13. All features of the meta function system are used but a particular emphasis is placed on the following elements.
Collaboration: collaboration is used in connection with each element of the medical system to enable collaboration between medical professionals and patients and suppliers and medical professionals
Video and file sharing: The video system is used to record all patient conferences and material generated independently and deliver them later, and optionally in connection with the collaboration system. The file system is used to deliver educational material with each element of the educational system.
Publication: The publication system is used by medical professionals to provide public access to the professional=s video and non-video medical information.
Task tracking and auditing: the task tracking and audit is used in connection with medical supervision and tracking
Billing: The billing system is used primarily by smaller medical education customers to provide a billing system for access to medical education material.

FIG. 6, desktop video system, item 14. The desktop video system is described in the cross referenced U.S. Provisional Patent Application 61/489,024.

In the case of pre-recorded video, the medical professional records the instruction, together with blackboard/whiteboard or PowerPoint if needed, outside of a patient context. Usually each point is recorded separately and put together on the system using the play list function. The video can be displayed thereafter on demand by patients and can be delivered simultaneously with a chat session by the instructor.

In the case of patient video, live patient consultation is recorded for the benefit of the patient and potentially the patients family. Sessions can be displayed thereafter either on demand or with a simultaneous chat session with the medical professional.

FIG. 6, cloud system, item 15. The cloud system is described in the cross referenced U.S. Provisional Patent Application 61/494,465. It is used herein in its entirety.

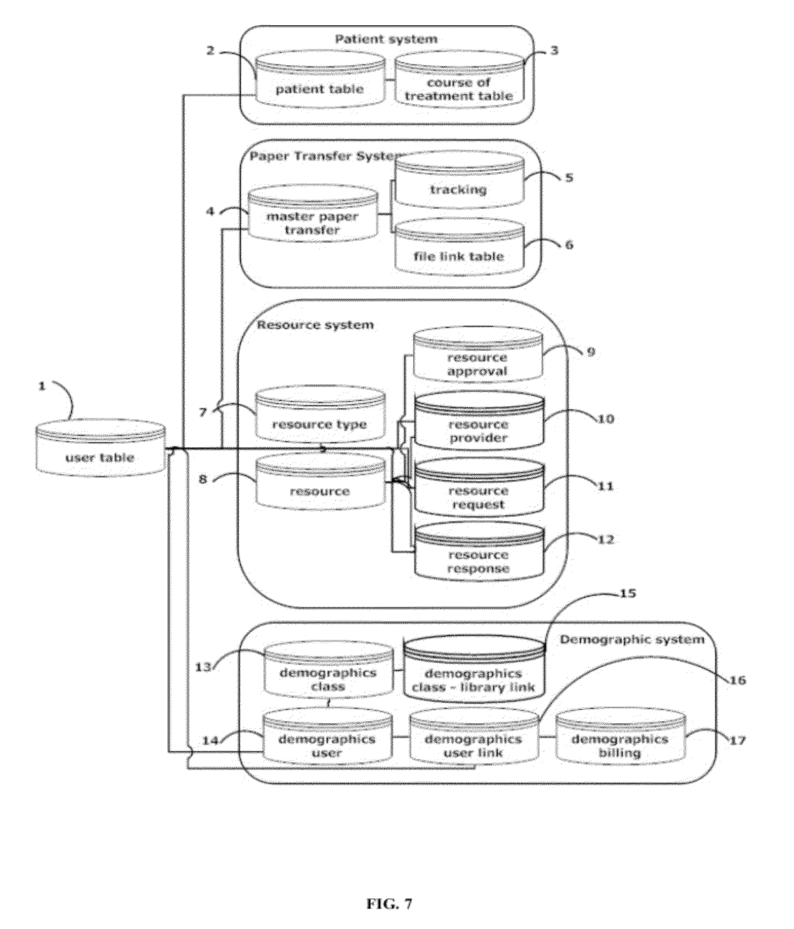

FIG. 6, medical collaboration system, item 16. The medical collaboration system is the data structures and interactions with the job and task system, as well as the other features of the other aforementioned elements, that manage and organize the interaction of the users of the system in a medical collaboration context. The medical collaboration system consists of the following components systems: patient, paper record transfer, resource requests and demographics. FIG. 7 describes the structure of the medical collaboration system.

FIG. 7, user-OUNIT link table, item 1. All links in the system start with the user-web application-user table-user OUNIT link table, which itself links users to OUNITS.

FIG. 7, patient system, patient table, item 2. This table is the central organizing table for patient care. It is a linking table, which links a patient=s user record to one or more medical professional=s user record. It contains customary demographic information about the patient specific to the linked medical professional. It is created by the medical professional.

FIG. 7, patient system, treatment table, item 3. This table organizes each course of treatment. It is a child of the master patient record, and is created by the medical professional. All educational material including video and non-video files are attached to this record, as is all collaboration on the course of treatment of the patient. This table also relies on the meta-function system described in the associated U.S. Provisional Patent Application 61/488,596 to provide additional collaborative tools such as video and file sharing, calendar, contacts, video conferencing, etc.

FIG. 7, paper record transfer system, master table, item 4. This table manages the process of transferring paper and electronic medical records from one user to another. This table is a linking table between the requestor and the requestee medical professionals. It includes the nature of the request (patient identity and nature of records sought) and the unique ID of the request. This table also relies on the meta-function system described in the associated U.S. Provisional Patent Application 61/488,596 to provide additional collaborative tools such as video and file sharing, calendar, contacts, video conferencing, etc.

FIG. 7, paper record transfer system, tracking table, item 5. this provides step by step tracking information for the progress of the transfer. This is maintained by the transfer staff but visible to all parties.

FIG. 7, paper record transfer table, file link table, item 6. This links the uploaded files to the parent paper record transfer table. This uses the existing non-video file system.

FIG. 7, resource system, type table, item 7. Resources are services provided on an immediate call basis, such as nursing, language translation, consulting. Resources can consist of a service provided by a single person, or one provided by many people. These are services which are pre-configured by an OUNIT (prequalified, payment methods established) and then are made available to members of an OUNIT.

The resource type table is a classification table maintained by the system staff which organizes into understandable categories the types of resources available to users.

FIG. 7, resource system, resource table, item 8. The resource table is a one row per resource table maintained by resource providers. Private resources are those available only to a singe OUNIT (one resource can have many private OUNIT links) Public resources are resources provided by third parties and are available to all OUNITS, subject to individual OUNIT approval. Also, public resources can be displayed on the system=s public web site for the general public to review, at the option of the resource provider.

FIG. 7, resource system, approval table, item 9. The resource approval table is a resource to OUNIT link table and indicates whether a particular resource is approved by a particular OUNIT.

FIG. 7, resource system, resource provider link, item 10. The resource user link table links the user record of the providers of the resource to the resource record. One or more users may provide the resource. This record includes the days and hours of availability of individual resource providers.

FIG. 7, resource system, resource request, item 11. The resource request table holds the records for each resource request. A requesting user selects a resource and a record is created in the resource request table to manage the process.

FIG. 7, resource system, resource response, item 12. Each provider connected to a resource is notified of each qualifying resource request and a record for each provider and each request is added to the resource response table. The requestor can see all the responses, the provider only theirs. This record tracks the responses to the request and the requestor=s response and selection process.

FIG. 7, demographics system, class table, item 13. The demographics system is intended to enable suppliers to provide content and software services of the type that do not require human intervention to users of the system. This table is the list of demographic classes. It is maintained by the system administrators. It uses the parent row zero feature to create hierarchical lists of classes.

FIG. 7, demographics system, user table, item 14. Users provide demographic information about themselves when they join (job class, geographic location). This information is used to channel prospective supplier solicitations to potentially interested teacher customers. The supplier uploads the video and non-video files to their account, and then identifies the demographic for delivery. The information is immediately available to all qualifying users, sometimes for free, sometimes on a pay per use bases. Medical professionals who view the material are jointly identified to the supplier and themselves.

FIG. 7, demographics system, class link table, item 15. The demographic class link table links demographic classes to supplier libraries. If the supplier=s service is geography limited, that information is included in the link. Other access requirements (limited time, specific URL or IP address, etc.) are also included.

FIG. 7, demographics system, user link table, item 16. The demographic user link table links users to supplier libraries. When a user finds supplier material that the user wants to access, this table creates the link. A second link is created for the object being linked to, in this case, a patient, or possibly an educational seminar. The link also includes the access limitations, such as time period.

FIG. 7, demographics system, billing table, item 17. Demographic billing table. The demographic billing table powers the billing system for suppliers and is linked to the demographic user link table. The demographic billing table records the terms of access to a library. The billing system is further described in U.S. Provisional Patent Application 61/488,596.

### Medical Collaboration System/Scenarios/Patient Process

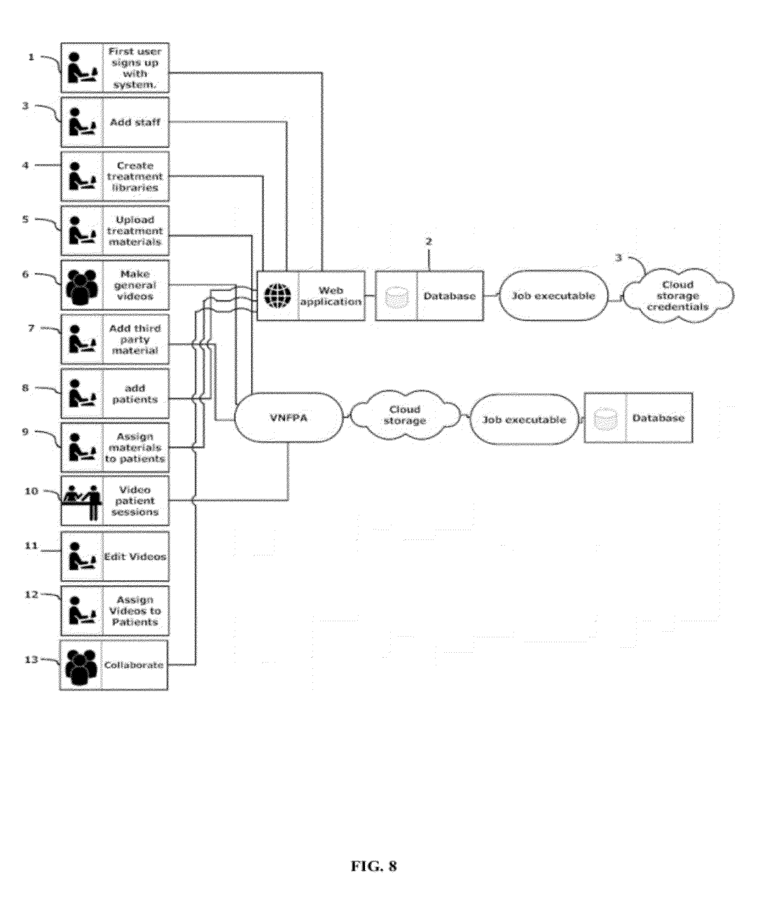

FIG. 8 describes the standard medical professional/patient process. This is the process by which medical professionals and patients collaborate.

FIG. 8, first user, item 1. The medical professional or staff member (the Afirst user@) signs up with the medical collaboration system. A medical practice organization is created for the first user. The first user provides an email address, contact information, and demographic information for the demographic system.

FIG. 8, cloud storage credentials, item 2. The system sets up a cloud storage account for the user. These cloud storage credentials are also the default for the OUNIT.

FIG. 8, add medical professionals and staff, item 3. The first user then adds other medical professionals and staff to the OUNIT. If the user is a patient, then they are also linked to at least one medical professional in the medical practice. Cloud storage credentials are created for each medical professional and staff.

FIG. 8, set up treatment libraries, item 4. Treatment libraries are created for each type of treatment. Treatment libraries organize all non-HIPAA specific files and videos into easily assignable treatments. Files of all types can be organized into subject matter libraries (usually by condition or course of treatment) and assigned as a group to a patient.

FIG. 8, add treatment materials, item 5. Medical professionals upload documents and other files to each treatment library.

FIG. 8, make general videos, item 6. Medical professionals acquire cameras and make general educational/treatment videos for treatments. Medical professionals can make general videos about medical topics using inexpensive hi-def cameras. They (or their staff) can then encode, edit, encrypt and upload the videos in their office using video and non-video file processing application (AVNFPA@) referred to in associated patent U.S. Provisional Patent Application 61/489,024 or by mailing the SD cards to system administrators. The videos can also be edited online Once the videos are edited and online, the videos can then be assigned to treatment libraries.

FIG. 8 add third party materials, item 7. Medical professionals add third party materials (documents, animations, video) provided by third parties through the supplier demographic system. Third parties (usually suppliers to the medical industry) can upload videos and files and make them available to medical professionals through the anonymous demographic data based system (meaning the medical professional=s contact information is not shared with the supplier until the medical professional makes use of the material—the material is made available based on the type of medical speciality of the medical professional).

FIG. 8, add patients, item 8. Medical professionals add patients by adding their email addresses and demographic information.

FIG. 8, assign videos and materials to patients, item 9. Treatment libraries can be assigned to patients through the web interface.

FIG. 8, video patient sessions, item 10. Medical professionals can video consultations with patients, hospital visits, therapy sessions, operations, etc. using inexpensive hi-def cameras.

FIG. 8, edit videos, item 11. Medical professionals (or their staff) can then encode, edit, and upload the videos in their office using VNFPA or by mailing the SD cards to the system staff FIG. 8, assign videos to patients, item 12. The medical professional or their staff can assign the videos to the patient. Patients are notified of the availability of new materia.

FIG. 8, collaborate with patients, item 13. Medical professionals can also use scheduling, video conferencing, email, chat and discussion groups to communicate with patients.

### Medical Collaboration/Scenarios/Resource Process

The resource system process enables the provision and consumption of resources by users of the system. FIG. 9 describes that process.

FIG. 9, resource process, system admins, item 1. The system admins set up a table of resource classes such as visiting nurse, consulting specialist, language translator.

FIG. 9, resource process, third party resource providers, item 2. Third party resource providers join the system as suppliers and add their resources to resource table and associate their resource with the resource class table. They include limitations which are primarily geographic areas, times available, etc. This process is monitored by the system admins.

FIG. 9, resource process, OUNIT providers, item 3. Each OUNIT can also add its own resources to the system which it can make private to the OUNIT or public to all OUNITS (i.e. be a third party resource provider).

FIG. 9, resource process, user providers, item 4. Users who will actually provide the resource join the system. They add a calendar style record to the resource availability table that shows when and where the user will be available for providing the resource. These can be added on a one time by one time basis, or on a recurring basis. The user must also include a phone number and an SMS connection.

FIG. 9, resource process, OUNIT approvals, item 5. OUNIT administrators approve individual third party resource providers, making the third party resource provider available to users in the OUNIT.

FIG. 9, resource process, consumer demand, item 6. A consumer of a resource navigates down the class table to the specific resources. The system asks for a geographic limitation (where necessary for the type of resource, e.g. visiting nurse) and a time constraint to narrow the search result set. The user then checks as many of the qualifying resource providers as from which the user desires to get a response.

FIG. 9, resource process, job executable adds request, item 7. The system/job executable adds the choices to the request table. There is one row per consumer/provider, that is, each provider of the requested resource is assigned a row. Each user can see their rows (that is, the consumer can see their requests, the provider can see their requests).

FIG. 9, resource process, job executable notifies all qualifying providers, item 8. The job executable system notifies the providers by email and SMS that they have a request outstanding. For control and billing purposes, the providers must log into the system to respond.

FIG. 9, resource process, resource provider, item 9. The provider users log into the system and check either yes or no on the request records as to whether they are willing to provide the resource.

FIG. 9, resource process, job executable notifies consumer, item 10. The job executable system notifies the consumer by email and SMS that they have a offer outstanding. For control and billing purposes, the providers must log into the system to respond.

FIG. 9, resource process, consumer chooses, item 11. The consumer user checks off those providers to which the user wishes to communicate, and is provided telephone numbers and SMS information contact the provider directly.

FIG. 9, resource process, negotiations, item 12. The system notifies the providers of their selection. The consumer and provider negotiate directly. Then, for the providers whose offer was accepted, both parties indicate such on the system for billing purposes. The provider would then provide the physical service (nursing, etc.). Some services will be provided directly over the system (video conferencing consultation, language translation services, etc.).

### Medical Collaboration/Medical Record Transfer

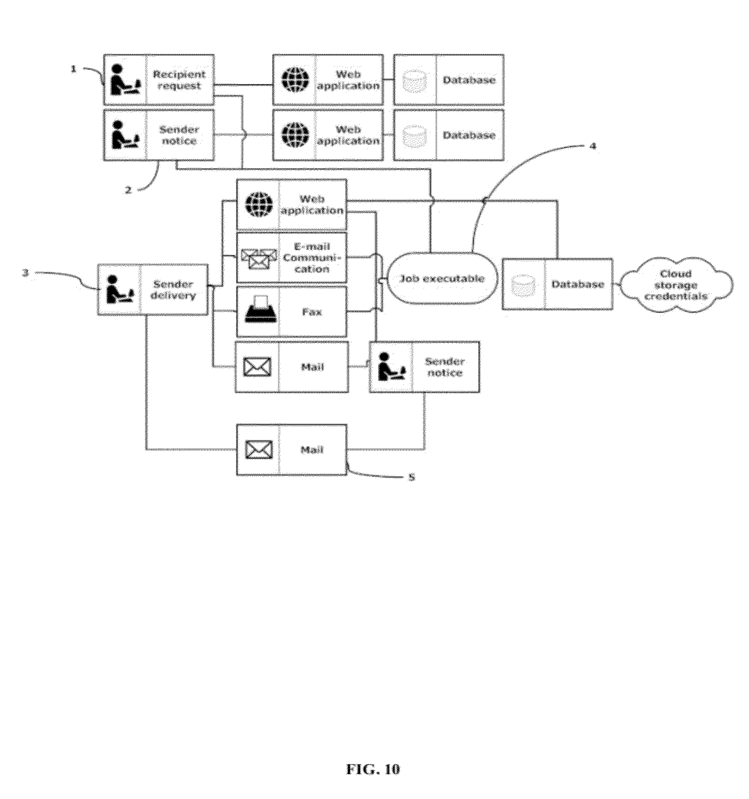

The medical record transfer system is a system of transferring paper based medical records from one medical professional to another and digitizing them through the system. FIG. 10 describes the medical record transfer system process.

FIG. 10, recipient request, item 1. The recipient medical professional enters a request in the request table, which lists all recipients (there can be more than one recipient) and the email address of the sender, with contact information.

FIG. 10, sender notification, item 2. The sender is notified by the system by email (the provider does not have to be a user on the system) or by the recipient directly.

FIG. 10, sender delivery, item 3. The sender sends the physical records by
direct upload to the system using the link provided in the email
faxing the records using SSL secured fac to the system email server,
postal mail to specialized mail centers which will digitize the documents and upload them to the sender=s account.

FIG. 10, system notice, item 4. The system notifies the recipients and the sender of the upload and availability of the records.

FIG. 10, postal mail, item 5. Paper records received by the system staff will then be postal mailed to the recipient.

The demographics system enables suppliers to provide information to medical professionals. FIG. 11 is a description of the demographic system process.

FIG. 11, demographic class table preparation, item 1. The system admins create a hierarchical listing of demographic types among the user population of medical professionals.

FIG. 11, medical professional joins system, item 2. When a supplier joins the system, the supplier creates educational libraries and links them to the class system. The supplier also links the educational library to the billing system to ensure billing for the use of the system. The supplier can also require manual approval for access, that is, a user must be approved by the supplier when requesting access.

FIG. 11, system polling, item 3. Periodically the system polls the users and the libraries and links those that match (and haven=t yet been linked) and notifies the supplier and the user of the new link. The link is used for usage tracking purposes.

FIG. 11, user usage, item 4. When a user finds supplier material that the user wants to access, the system links the user and the educational library. A second link is created for the object being linked to, in this case, a patient, or possibly an educational seminar.

FIG. 11, billing, item 5. When a user accesses a link educational library, the billing system is triggered. The billing system is further described in U.S. Provisional Patent Application 61/488,596.

### Additional Embodiments

The system as described uses the technology of one type of cloud system and server software but can be extended to any cloud system and server software. It can be further extended to non-cloud based server systems.

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### CONCLUSION, RAMIFICATIONS AND SCOPE

The system described herein contains all of the advantages described in the associated patents In an education context, the system has the following advantages.

The system's use of cloud technology provides crucial benefits to the user. Current education systems rely on their customers=internal networks to operate. Cloud computing removes the entire technical infrastructure to the Web, radically lowers costs, radically increases scalability, and provides world wide distribution.

The system uses a new generation of inexpensive hi-def digital cameras and the emerging H.264 video standard. The system can handle thousands of hours of educational video encoding, transfer and storage per week.

The system has a simple, clear and understandable user interface that matches the business methods of the users in their education activities outside the system. The system provides an integrated Web-delivered education and collaboration management system to manage and distribute video and other information related files to students in a secure manner and to manage the educational process. The system provides live chat, video-conferencing, SMS text messaging, discussion groups and file sharing to further educational and medical tasks. The system enables live streaming of classes in real time with feedback from live audiences by live chat, and also stores the streamed video for later use.

The system contains specific features intended for the medical profession. This includes a user interface that matches medical practices, including organization, medical professional, and patient levels. The system includes a process whereby paper based medical records are digitized and delivered through the system. And its live streaming service provides direct live interactions between patients, medical professionals and service providers such as language translation providers.

The system described here is a fully functional cloud based Windows system that maintains encryption over all files, all video, all network communications, and all database transactions. It eliminates these entry points for access by cloud personnel. It provides complete encryption in keeping with public standards such as HIPAA. At no point in the operation of the system is any file or any communication transferred in the clear. At no point do cloud personnel have access to unencrypted information.

We claim:

1. A method of managing a system of servers of various types on a cloud system, comprising managing virtual storage and virtual servers and doing one or both of the following:
a. maintaining a model virtual server containing software which is able to fulfill any server role needed by the system; and if one server role that is then being over-utilized, then (i) creating from said model virtual server a new instance of said model virtual server of the server role that is being over-utilized; and (ii) communicating adjustments to integrate said new instance into said virtual servers; or
b. if one server role is being under-utilized, (i) causing one virtual server of that role to shut down, and (ii) communicating adjustments so that said virtual servers adjust to the fact of said one virtual server shutting down.

2. The method of claim 1, wherein the method is capable of presenting files that are larger than 2 gigabytes from said cloud system.

3. The method of claim 1, wherein the method comprises causing both (a) and (b).

4. The method of claim 1, further comprising caching said virtual servers to storage via the internet.

5. The method of claim 4, wherein said caching is substantially encrypted.

6. The method of claim 4, wherein said caching is entirely encrypted.

7. The method of claim 1, wherein said maintaining of virtual servers is substantially encrypted.

8. The method of claim 1, wherein said maintaining of virtual servers is entirely encrypted.

9. The method of claim 1, wherein said virtual storage is substantially encrypted.

10. The method of claim 1, wherein said virtual storage is entirely encrypted.

11. A system with a means of managing a system of servers of various types on a cloud system, comprising managing virtual storage and virtual servers and doing one or both of the following:
a. a means of maintaining a model virtual server containing software which is able to fulfill any server role needed by the system; and if one server role that is then being over-utilized, then (i) creating from said model virtual server a new instance of said model virtual server of the server role that is being over-utilized; and (ii) communicating adjustments to integrate said new instance into said virtual servers; or
b. if one server role is being under-utilized, a means of (i) causing one virtual server of that role to shut down, and (ii) communicating adjustments so that said virtual servers adjust to the fact of said one virtual server shutting down.

12. The system of claim 1, wherein the system is capable of presenting files that are larger than 2 gigabytes from said cloud system.

13. The system of claim 1, wherein the system comprises causing both (a) and (b).

14. The system of claim 1, further comprising caching said virtual servers to storage via the internet.

15. The system of claim 4, wherein said caching is substantially encrypted.

16. The system of claim 4, wherein said caching is entirely encrypted.

17. The system of claim 1, wherein said maintaining of virtual servers is substantially encrypted.

18. The system of claim 1, wherein said maintaining of virtual servers is entirely encrypted.

19. The system of claim 1, wherein said virtual storage is substantially encrypted.

20. The system of claim 1, wherein said virtual storage is entirely encrypted.
